(19) United States
(12) Patent Application Publication
(10) Pub. No.: US 2014/0117950 A1
(43) Pub. Date: May 1, 2014

(54) VOLTAGE REGULATOR CIRCUIT

(71) Applicant: STMICROELECTRONICS ASIA PACIFIC PTE LTD, Singapore (SG)

(72) Inventors: Eng Jye Ng, Singapore (SG); Kien Beng Tan, Singapore (SG)

(73) Assignee: STMICROELECTRONICS ASIA PACIFIC PTE LTD, Singapore (SG)

(21) Appl. No.: 13/662,612

(22) Filed: Oct. 29, 2012

(51) Int. Cl. G05F 1/10

(52) U.S. Cl. 323/265

(57) ABSTRACT

A voltage regulator circuit includes a differential amplifier stage. The gate terminal of a first n-channel MOSFET is coupled to an output of the differential amplifier stage. A resistor is coupled between the drain terminal and gate terminal of the first n-channel MOSFET. The drain terminal of the first n-channel MOSFET drives the gate of a second n-channel MOSFET whose drain terminal is at the input of a current mirror circuit. An output of the current mirror circuit forms the regulated voltage output. A feedback circuit is coupled between the regulated voltage output and one input of the voltage regulator circuit. Another input of the voltage regulator circuit is configured to receive a reference voltage.

### TECHNICAL FIELD

The present invention relates to voltage regulator circuits and, in particular, to an enhanced stability voltage regulator circuit.

### BACKGROUND

Many electronic circuits require a regulated supply voltage for operation. The prior art is replete with different types of voltage regulator circuits. It is known by those skilled in the art that stability of the voltage regulator must be taken into consideration when designing the regulator circuitry.

Normally, a large capacitor (for example, with an nF to μF capacitance value) is coupled to the output of the voltage regulator to filter out voltage noise. The result of adding such a capacitor to the voltage regulator circuit is to locate the first dominant pole of the circuit at the regulator output. To provide for stabile operation, the circuit designer must ensure that all internal poles of the regulator circuit are located at a higher frequency than the dominant pole frequency.

Taha, U.S. Pat. No. 7,755,338, the disclosure of which is incorporated by reference, teaches a multi-stage amplifier (shown in FIG. 1) for use in a voltage regulator circuit. The amplifier has a folded cascode stage 60 with a differential input. One input of the folded cascode stage is configured to receive a reference voltage (Vref). Another input of the folded cascode stage is configured to receive a feedback voltage (Vfbk). The single-ended output 62 of the folded cascode stage 60 is coupled to the input of a second amplifying (gain) stage 64. The second amplifying (gain) stage 64 includes a p-channel transistor 66 whose source-drain path is coupled at output node 68 in series with the source-drain path of an n-channel transistor 70. The gate of the p-channel transistor 66 is biased with an appropriate biasing voltage. The gate of the n-channel transistor 70 is coupled to the single-ended output 62 of the folded cascode stage 60. A feedback resistor 72 is coupled between the output node 68 and the gate of the n-channel transistor 70.

The feedback resistor 72 is provided to lower resistance and improve stability. The feedback resistor 72 provides a means for reducing output resistance of the second amplifying (gain) stage 64. Notwithstanding the improvement in stability provided by the inclusion of the feedback resistor 72, it is recognized that the second amplifying (gain) stage 64 suffers from a voltage swing problem. If the output load varies greatly, there can be a large voltage swing at the output node 68. The biasing current (Vbias2) for the p-channel transistor 66 and the feedback resistor 72 need to be large in order to ensure that there is sufficient voltage swing available at output node 68. On the other hand, the voltage swing at node 68 determines the offset current through the feedback resistor 72, and this can introduce an error into the regulated output voltage of the voltage regulator circuit. A need accordingly exists in the art to address this problem.

### SUMMARY

A common drain stage may be provided as a buffering circuit within the voltage regulator in order to address stability concerns. However, improvement in stability is still needed. In an embodiment, the common drain stage is replaced with a common source stage with a gate-to-drain feedback resistance. A low impedance node introduced by the common source stage pushes an internal second pole of the regulator circuit further to the higher frequency so as to provide improved stability for regulator operation. Additionally, an output load tracking circuit is configured to ensure sufficient voltage swing at the regulator output.

In an embodiment, a voltage regulator circuit comprises: a differential amplifier stage having a first input configured to receive a reference voltage and a second input; a first n-channel MOSFET having a gate terminal, a common source terminal and a drain terminal, wherein the gate terminal is coupled to an output of the differential amplifier stage; a resistance coupled between the drain terminal and the gate terminal of the n-channel MOSFET; a second n-channel MOSFET having a gate terminal coupled to the drain terminal of the first n-channel MOSFET and having a drain terminal; a current mirror having an input node coupled to the drain terminal of the second n-channel MOSFET and having an output node; and a feedback circuit coupled between the output node and the second input of the differential amplifier stage.

In an embodiment, a circuit comprises: a differential amplifier stage having a first input configured to receive a reference voltage and a second input; a common source stage buffer circuit having an input coupled to an output of the differential amplifier stage and having an output; a resistance coupled between the output of the common source stage buffer circuit and the input of the common source stage buffer circuit; an output load tracking circuit having an input coupled to the output of the common source stage buffer tracking circuit and an output configured to be coupled to a load; and a feedback circuit coupled between the output of the output load tracking circuit and the second input of the differential amplifier stage.

### BRIEF DESCRIPTION OF THE DRAWINGS

For a better understanding of the embodiments, reference will now be made by way of example only to the accompanying figures in which:

FIG. 1 is a circuit diagram of a multi-stage amplifier for use in a voltage regulator circuit;

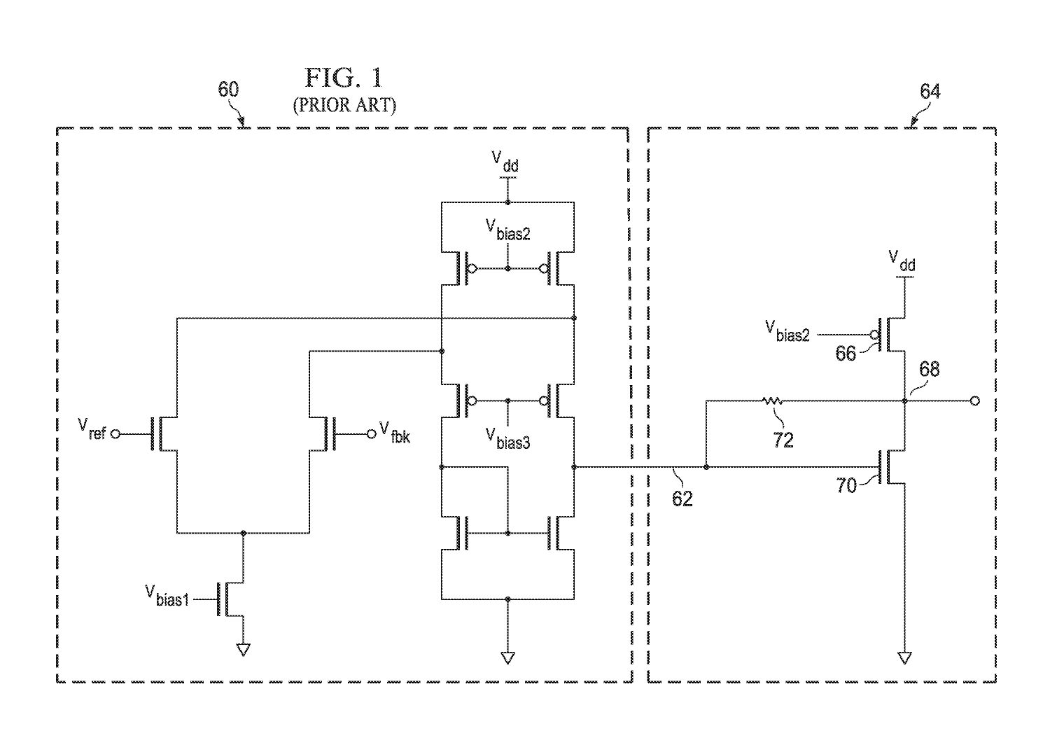

FIG. 2 is a circuit diagram of a voltage regulator circuit with a common drain stage buffer;

FIG. 3 is a circuit diagram of a voltage regulator circuit with a common source stage buffer and an output load tracking circuit;

FIGS. 4A and 4B illustrate plots of gain and phase, respectively, for the voltage regulator circuit of FIG. 2; and

FIGS. 5A and 5B illustrate plots of gain and phase, respectively, for the voltage regulator circuit of FIG. 3.

### DETAILED DESCRIPTION OF THE DRAWINGS

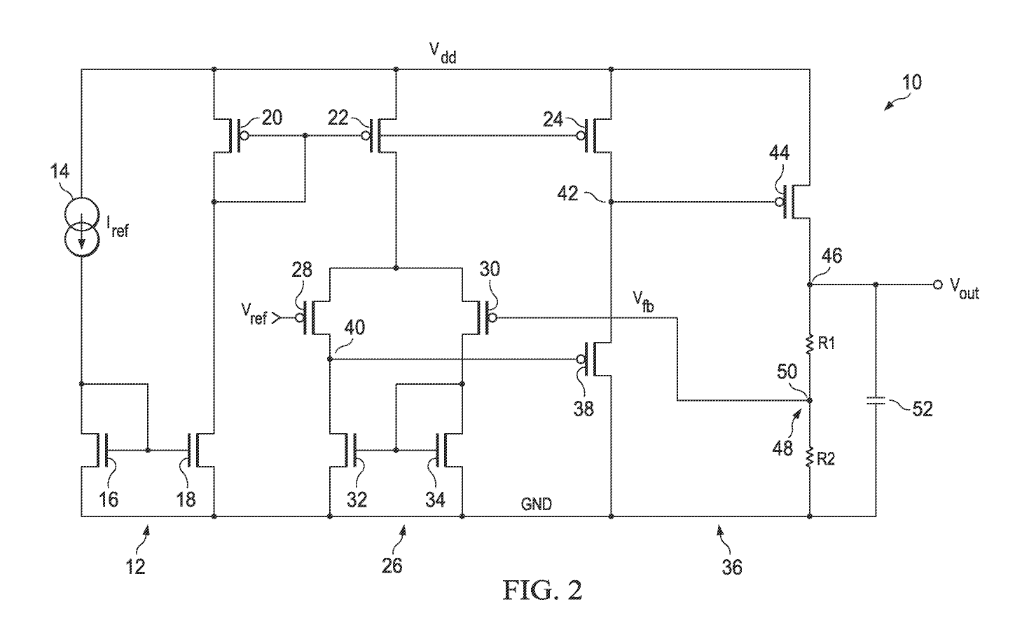

Reference is now made to FIG. 2 which is a circuit diagram of a voltage regulator circuit 10 with a common drain stage buffer. The circuit 10 includes a biasing circuit 12. The biasing circuit 12 includes a reference current generator 14 coupled in series with the source-drain circuit of an n-channel MOSFET 16 between a first voltage supply node (Vdd) and a second voltage supply node (GND). The gate of MOSFET 16 is connected to the drain of MOSFET 16 and to the gate of n-channel MOSFET 18 to form a current mirror. The biasing circuit 12 further includes a p-channel MOSFET 20 whose source-drain circuit is coupled in series with the source-drain circuit of the n-channel MOSFET 18 (also between the first voltage supply node and second voltage supply node). The gate of MOSFET 20 is connected to the drain of MOSFET 20 and to the gate of p-channel MOSFET 22 and the gate of p-channel MOSFET 24 to form a current mirror.

The circuit 10 further includes a differential amplifier circuit 26 coupled between the first voltage supply node and second voltage supply node. The differential amplifier circuit 26 includes the MOSFET 22 functioning as a tail current source and coupled to the first voltage supply node. A first input of the differential amplifier 26 is received at the gate of p-channel MOSFET 28 whose drain is coupled to the drain of MOSFET 22. A second input of the differential amplifier 26 is received at the gate of p-channel MOSFET 30 whose drain is coupled to the drain of MOSFET 22. The source-drain circuit of MOSFET 28 is coupled in series with the source-drain circuit of an n-channel

MOSFET 32. The source-drain circuit of MOSFET 30 is coupled in series with the source-drain circuit of an n-channel MOSFET 34. The gate of MOSFET 34 is connected to the drain of MOSFET 34 and to the gate of MOSFET 32 to form a current mirror.

The circuit 10 further includes an output amplifier stage 36 coupled between the first voltage supply node and second voltage supply node. The output amplifier stage has an input at the gate of p-channel MOSFET 38 which is coupled to an output 40 of the differential amplifier circuit 26. The source-drain circuit of MOSFET 38 is coupled in series with the source-drain circuit of the MOSFET 24 (in the current mirror arrangement with MOSFETs 20 and 22). MOSFET 38 is configured in a common drain mode and node 42 forms an output of the common drain amplifier formed by MOSFET 38. A gate of p-channel MOSFET 44 is coupled to the node 42. Node 46 forms an output of the output amplifier stage 36 generating the regulated output voltage Vout.

A voltage divider circuit 48 is coupled between the node 46 and the second supply voltage node. The voltage divider circuit 48 is formed by a pair of series connected resistances R1 and R2. A feedback voltage Vfb is generated at a tap node 50 which is coupled to the second input of the differential amplifier 26. The first input of the differential amplifier 26 is coupled to receive a reference voltage Vref. A capacitance 52 is coupled between the node 46 and the second supply voltage node.

The output capacitance 52 functions to filter voltage noise from the regulated output voltage Vout. The output capacitance is typically in the range of nF to μF. As a result, the first dominant pole of the regulator circuit is typically located at the output of the regulator. This introduces a potential instability in regulator operation. The common drain configured output amplifier stage 36 functions as a buffer stage within the voltage regulator circuit 10 and serves to improve stability. The gate of MOSFET 38 presents a high impedance input to the output amplifier stage 36. The internal pole of the voltage regulator circuit becomes non-dominant due to separation of a highly capacitive node at the gate of MOSFET 44 and a high impedance node at the output node 40 of the differential amplifier circuit 26.

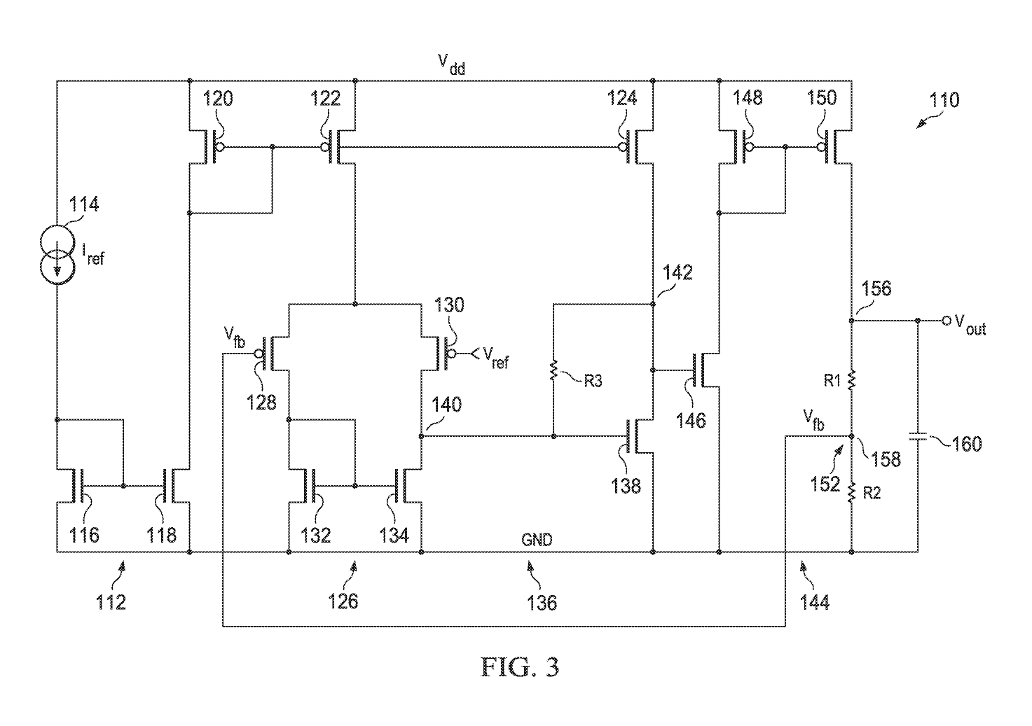

Reference is now made to FIG. 3 which is a circuit diagram of an embodiment of a voltage regulator circuit 110 with a common source stage buffer and an output load tracking circuit. The circuit 110 includes a biasing circuit 112. The biasing circuit 112 includes a reference current generator 114 coupled in series with the source-drain circuit of an n-channel MOSFET 116 between a first voltage supply node (Vdd) and a second voltage supply node (GND). The gate of MOSFET 116 is connected to the drain of MOSFET 116 and to the gate of n-channel MOSFET 118 to form a current mirror. The biasing circuit 112 further includes a p-channel MOSFET 120 whose source-drain circuit is coupled in series with the source-drain circuit of the n-channel MOSFET 118 (also between the first voltage supply node and second voltage supply node). The gate of MOSFET 120 is connected to the drain of MOSFET 120 and to the gate of p-channel MOSFET 122 and the gate of p-channel MOSFET 124 to form a current mirror.

The circuit 110 further includes a differential amplifier circuit 126 coupled between the first voltage supply node and second voltage supply node. The differential amplifier circuit 126 includes the MOSFET 122 functioning as a tail current source and coupled to the first voltage supply node. A first input of the differential amplifier 126 is received at the gate (control terminal) of p-channel MOSFET 128 whose drain (conduction terminal) is coupled to the drain of MOSFET 122. A second input of the differential amplifier 126 is received at the gate (control terminal) of p-channel MOSFET 130 whose drain (conduction terminal) is coupled to the drain of MOSFET 122. The source-drain circuit of MOSFET 128 is coupled in series with the source-drain circuit of an n-channel MOSFET 132. The source-drain circuit of MOSFET 130 is coupled in series with the source-drain circuit of an n-channel MOSFET 134. The gate of MOSFET 132 is connected to drain of MOSFET 132 and to the gate of MOSFET 134 to form a current mirror.

The circuit 110 further includes a common source stage buffer circuit 136 coupled between the first voltage supply node and second voltage supply node. The common source stage buffer circuit 136 has an input at the gate of n-channel MOSFET 138 which is coupled to an output 140 of the differential amplifier circuit 126. The source-drain circuit of MOSFET 138 is coupled in series with the source-drain circuit of the MOSFET 124 (in the current mirror arrangement with MOSFETs 120 and 122). MOSFET 138 is configured in a common source mode and node 142 forms an output of the common source amplifier formed by MOSFET 138. A resistance R3 is coupled between the node 142 and the node 140.

The circuit 110 further includes an output load tracking circuit 144 coupled between the first voltage supply node and second voltage supply node. The output load tracking circuit 144 has an input at the gate of n-channel MOSFET 146 which is coupled to node 142 at the output of the common source amplifier formed by MOSFET 138. The source-drain circuit of MOSFET 146 is coupled in series with the source-drain circuit of a p-channel MOSFET 148. The gate of MOSFET 148 is connected to the drain of MOSFET 148 and to the gate of MOSFET 150 to form a current mirror. The drain of the MOSFET 150 at node 156 forms an output of the output amplifier stage 136 generating the regulated output voltage Vout.

A voltage divider circuit 152 is coupled between the node 156 and the second supply voltage node. The voltage divider circuit 152 is formed by a pair of series connected resistances R1 and R2. A feedback voltage Vfb is generated at a tap node 158 which is coupled to the first input of the differential amplifier 126. The second input of the differential amplifier 126 is coupled to receive a reference voltage Vref. A capacitance 160 is coupled between the node 146 and the second supply voltage node. The load of the regulator is coupled to Vout.

It will thus be noted that the voltage regulator circuit 110 differs from the voltage regulator circuit 10 in that the voltage regulator circuit 110 uses a common source configured output amplifier stage 136 with feedback resistance R3, while the voltage regulator circuit 10 uses a common drain configured output amplifier stage 36. The common source configured buffer circuit (with transistor 138) has high gain which is reduced by the presence of the feedback resistance R3 in order to substantially mimic the unity gain buffer stage operation of the common drain configured circuit (with transistor 38).

Although the use of the common source configured output amplifier stage with feedback improves stability, it is important to ensure that there is sufficient voltage swing available at the output node 156 in response to load variation (see, discussion of the Taha reference above). The configuration of the output load tracking circuit 144 addresses this concern.

The output capacitance 160 functions to filter voltage noise from the regulated output voltage Vout. The output capacitance is typically in the range of nF to μF. As a result, the first dominant pole of the regulator circuit is typically located at the output of the regulator. This introduces a potential instability in regulator operation. As a result, all internal node impedances should be kept as small as possible. The common source stage buffer circuit 136 and output load tracking circuit 144 are configured keep the internal node resistances small. Furthermore, the voltage swing at node 142 is reduced by the output load tracking circuit 144 which advantageously reduces error in Vout, enables selection of a smaller resistance for feedback resistor R3 and reduces the amount of current required to bias transistor 124. The common source stage buffer circuit 136 functions as a buffer stage within the voltage regulator circuit 110 and serves to further improve stability in comparison to the voltage regulator circuit 10. The gate of MOSFET 138 presents a high impedance input to the output amplifier stage 136. The input impedance Ri at the gate of MOSFET 138 is given by the following equation:

Ri=(r₁₃₈+R3)/(1+gm₁₃₈×r₁₃₈)

Wherein, r₁₃₈ is the input impedance of MOSFET 138 and gm₁₃₈ is the transconductance of MOSFET 138.

The output impedance Ro of MOSFET 138 (at the drain terminal) is given by the following equation:

Ro=((r₁₂₆+R3)×r₁₃₈)/((gm₁₃₈×r₁₂₆×r₁₃₈)+r₁₃₈+r₁₂₆+R3)

Wherein, r₁₂₆ is the output impedance of the amplifier 126.

If R3<<r₁₂₆ and r₁₃₈, for example if R3 is about a few hundred kilo-ohms (for example about 200KΩ) and r₁₂₆ and r₁₃₈ are each about a few mega-ohms for example about 5MΩ and 2MΩ, respectively), the forgoing equations simplify to:

Ri=1/gm₁₃₈, and

Ro=(1/gm₁₃₈)//(r₁₃₈)//(r₁₂₆)

Those skilled in the art will thus recognize that all internal poles of the voltage regulator circuit 110 are kept at higher frequency and become non-dominant relative to the external pole contributed by the capacitance 160. This serves to improve overall stability of the regulator circuit.

With respect to the output load tracking circuit 144, MOSFET 150 is the output drive transistor. The MOSFET 148 functions to sense output load based the ratioed size (width and length) of transistor 148 to transistor 150. The MOSFET 146 functions as a gain stage so as to reduce voltage swing at node 142.

The pole located at the common gates of transistors 148 and 150 is kept at a high frequency since the output impedance of transistor 148 is inversely proportional to the transconductance of transistor 148. When the load at the output Vout increases, the current in the source-drain circuit of transistor 148 also increases. The dominant pole is linearly proportional to the load current, but the pole located at the common gates of transistors 148 and 150 is instead proportional to the square root of the load current. This is shown as follows:

Pdominant=1/(r₁₅₀×Cload), when r₁₅₀>>R1+R2

Where r150 is the output impedance of transistor 150.

Where r₁₅₀ is inversely proportional to lload and Pdominant is directly proportional to lload.

Pcg=1/(r₁₄₈×C₁₅₀)

Where Pcg is the pole located at the common gates of transistors 148 and 150, r₁₄₈ is the output impedance of transistor 148, and C₁₅₀ is the gate capacitance of transistor 150.

r₁₄₈≈1/g₁₄₈ which is inversely proportional to sqrt(I₁₄₈)

Where g₁₄₈ is the transconductance of transistor 148, and I₁₄₈ is the drain-source current of transistor 148.

sqrt(I₁₄₈)=sqrt(load×(W/L)₁₄₈/(W/L)₁₅₀)

Pcg is thus proportional to sqrt(lload).

This means that as the dominant pole becomes less dominant, the pole located at the common gates of transistors 148 and 150 likewise is pushed to become less dominant. As a result, there is an improvement in stability.

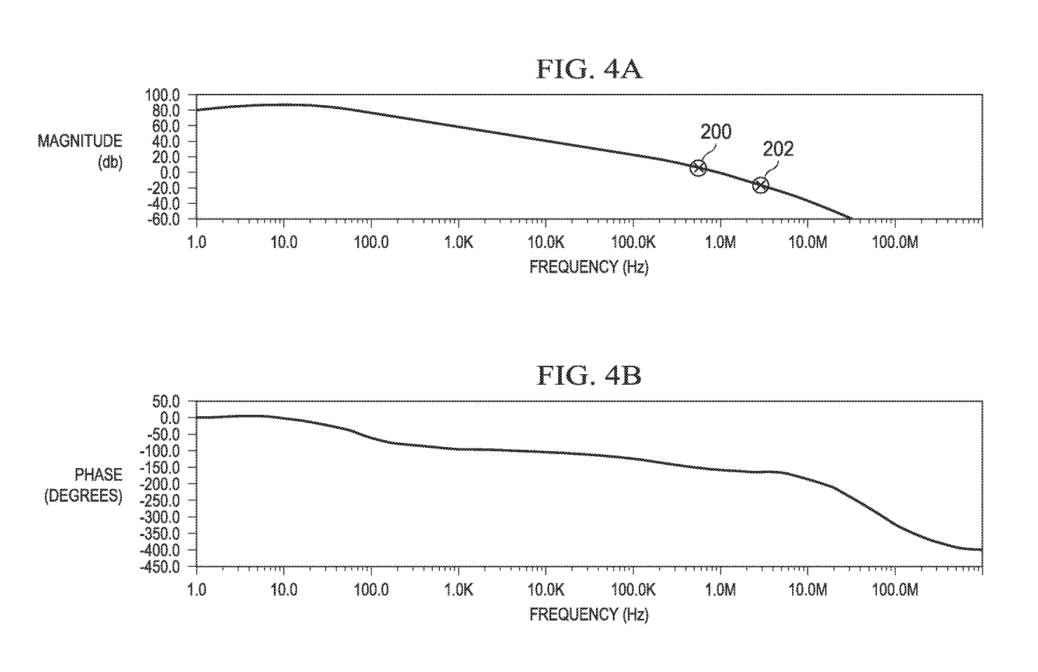

The common drain configured circuit 10 of FIG. 2 was simulated. For that simulation, FIG. 4A plots gain and FIG. 4B plots phase. The gain crossover 200 occurs at about 556 kHz and the phase crossover 202 occurs at about 2.8 MHz. This results in a gain margin of about 25.9 dB, and a phase margin of about 40.9 degrees.

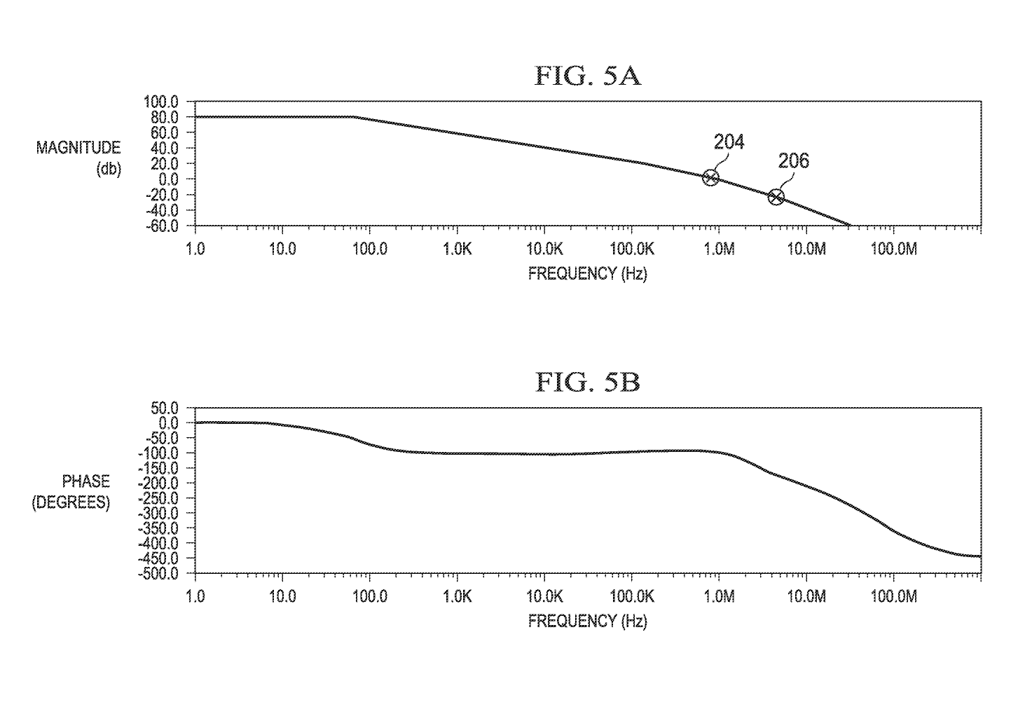

The common source configured circuit 110 of FIG. 3 was also simulated. For that simulation, FIG. 5A plots gain and FIG. 5B plots phase. The gain crossover 204 occurs at about 830.5 kHz and the phase crossover 202 occurs at 4.2 MHz. This results in a gain margin of about 16.8 dB, and a phase margin of about 74.2 degrees. Thus, phase margin with the common source configured circuit 110 of FIG. 3 is improved by about 33 degrees over the common drain configured circuit 10 of FIG. 2. This is due to the internal second pole of the common source configured circuit 110 of FIG. 3 being pushed further to the higher frequency by the low impedance node introduced by the common source stage and feedback resistor circuitry. As a result, the common source configured circuit 110 of FIG. 3 will be more stable than the common drain configured circuit 10 of FIG. 2.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

What is claimed is:

1. A voltage regulator circuit, comprising:
a differential amplifier stage having a first input configured to receive a reference voltage and a second input;
a first n-channel MOSFET having a gate terminal, a common source terminal and a drain terminal, wherein the gate terminal is coupled to an output of the differential amplifier stage;
a resistance coupled between the drain terminal and the gate terminal of the n-channel MOSFET;
a second n-channel MOSFET having a gate terminal coupled to the drain terminal of the first n-channel MOSFET and having a drain terminal;
a current mirror having an input node coupled to the drain terminal of the second n-channel MOSFET and having an output node; and
a feedback circuit coupled between the output node and the second input of the differential amplifier stage.

2. The circuit of claim 1, wherein the feedback circuit comprises a voltage divider circuit.

3. The circuit of claim 1, wherein the resistance is a resistor coupled between the drain terminal and the gate terminal of the n-channel MOSFET.

4. The circuit of claim 1, wherein the output of the differential amplifier stage has a first output impedance and the drain terminal of the n-channel MOSFET has a second output impedance, and wherein the resistance is substantially smaller than both the first and second output impedances.

5. The circuit of claim 1, further comprising a current source configured to source current to the drain terminal of the first n-channel MOSFET.

6. The circuit of claim 1, wherein the differential amplifier stage includes a first input transistor having a control terminal forming the first input, said first input transistor having a conduction terminal coupled to the output of the differential amplifier stage.

7. The circuit of claim 6, wherein the differential amplifier stage further includes a current mirroring circuit coupled at the output of the differential amplifier stage to the conduction terminal of the first input transistor.

8. The circuit of claim 7, wherein the differential amplifier stage includes a second input transistor having a control terminal forming the second input, said second input transistor having a conduction terminal coupled to the current mirroring circuit.

9. The circuit of claim 1, wherein the resistance is formed by a resistor having a first terminal directly connected to the drain terminal of the n-channel MOSFET and a second terminal directly connected to the gate terminal of the n-channel MOSFET.

10. The circuit of claim 9, wherein the second terminal of the resistor is further directly connected to the output of the differential amplifier.

11. The circuit of claim 9, wherein the first terminal of the resistor is further directly connected to the gate terminal of the second n-channel MOSFET.

12. The circuit of claim 1, wherein the feedback circuit comprises a feedback resistor coupled between the output node of the current mirror and the second input of the differential amplifier stage.

13. The circuit of claim 12, wherein the feedback resistor has a first terminal directly connected to the output node of the current mirror and a second terminal directly connected to the second input of the differential amplifier stage.

14. The circuit of claim 1, wherein the current mirror comprises a first p-channel MOSFET having a drain terminal coupled to the drain terminal of the second n-channel MOSFET and further comprising a second p-channel MOSFET having a shared gate connection with the first p-channel MOSFET.

15. A circuit, comprising:
a differential amplifier stage having a first input configured to receive a reference voltage and a second input;
a common source stage buffer circuit having an input coupled to an output of the differential amplifier stage and having an output;
a resistance coupled between the output of the common source stage buffer circuit and the input of the common source stage buffer circuit;
an output load tracking circuit having an input coupled to the output of the common source stage buffer tracking circuit and an output configured to be coupled to a load; and
a feedback circuit coupled between the output of the output load tracking circuit and the second input of the differential amplifier stage.

16. The circuit of claim 15, wherein the resistance is configured to constrain a gain of the common source stage buffer circuit to be substantially unity gain.

17. The circuit of claim 15, wherein said output load tracking circuit includes a gain stage configured to support reduced voltage swing at the output of the common source stage buffer circuit.

18. The circuit of claim 17, wherein said output load tracking circuit further includes a current mirror circuit having an input coupled to an output of the gain stage and an output comprising said output configured to be coupled to the load.
